(19) United States
(12) Patent Application Publication
(10) Pub. No.: US 2026/0082204 A1
(43) Pub. Date: Mar. 19, 2026

(54) METHODS AND SYSTEMS FOR IMPROVING NETWORK REPOSITORY FUNCTION (NRF) SUBSCRIPTION

(71) Applicant: T-Mobile USA, Inc., Bellevue, WA (US)

(72) Inventors: Narayanan Govindan Kasi, Olathe, KS (US); Saravana Velusamy, Overland Park, KS (US)

(21) Appl. No.: 18/889,027

(22) Filed: Sep. 18, 2024

(51) Int. Cl. H04W 8/20; H04W 8/00; H04W 8/18

(52) U.S. Cl. CPC H04W 8/20; H04W 8/005; H04W 8/183

(57) ABSTRACT

Methods and systems for improving network repository function subscription are described herein. According to an implementation, a network repository function may receive a request to subscribe to a network function producer from a network function consumer. In response to the request, the network repository function may transmit an instance of a profile of the network function producer to the network function consumer. The network repository function may further receive a second request to re-subscribe to the network function producer from the network function consumer. The second request may include the instance of the profile. The network repository function may locate the profile of the network function producer in a data storage, and further compare the profile with the instance of the profile provided by the network function consumer. The network repository function may transmit a difference between the profile and the instance of the profile to the network function consumer.

The Network Repository Function (NRF) is a critical component in the Fifth Generation (5G) core network as defined by the Third Generation Partnership Project (3GPP). In the 5G core network, various network functions (NFs) are interconnected. These network functions require a centralized registry to discover and communicate with each other. As the 5G core network evolves to provide more services and flexibility than its predecessors, its architecture requires efficient service management and discovery. The NRF, acting as a central registry, is interconnected with almost every network function in the 5G core network, such as Access and Mobility Management Function (AMF), Session Management Function (SMF), User Plane Function (UPF), etc. It allows these network functions to register their services and discover other necessary services.

When the NRF has a fault, it may lose subscription data and reject subscription data. When a NF consumer (i.e., the network function requesting a service) tries to re-subscribe for the same NF producer (i.e., the network function providing the service), the NF producer profile on the NRF may not match the one in the NF consumer, depending on the time of the fault and the subscription. In a hierarchical implementation, the NRF may forward the request to another NRF in a next hierarchy. If the NF producer is still undiscoverable, an error code indicating the profile not found is returned to the NF consumer. As there are no guidelines as to how long the NF consumer should wait till the next retry, some NF consumers may aggressively attempt to subscribe, causing additional load on multiple NRFs.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which methods for improving network repository function subscription are implemented according to an example of the present disclosure.

FIG. 2 illustrates an example scenario, in which methods for improving network repository function subscription are implemented according to an example of the present disclosure.

FIG. 3 illustrates an example scenario, in which methods for improving network repository function subscription are implemented according to another example of the present disclosure.

FIG. 4 illustrates an example process for improving network repository function subscription according to an example of the present disclosure.

FIG. 5 illustrates an example process for improving network repository function subscription according to another example of the present disclosure.

FIG. 6 illustrates an example computing device, in which methods for improving network repository function subscription are implemented according to an example of the present disclosure.

### DETAILED DESCRIPTION

Techniques for improving network repository function subscription are disclosed herein.

In some implementations, a method for improving network repository function subscription may be implemented by a computing device associated with a network repository function (NRF) in a wireless communication network.

The computing device may include a processor and a non-transitory computer-readable memory storing computer-executable instructions that, when executed by the processor, cause the processor to manage the subscription data associated with various network functions registered therein. The computing device may receive, from a first network function, a request to subscribe to a second network function. The first network function may act as a network function (NF) consumer that uses the service provided by the second network function, acting as a network function (NF) producer. In response to the request, the computing device may transmit, to the network function consumer, an instance of a profile of the network function producer. As discussed herein, the NF consumer and the NF producer may register their profiles with the computing device (e.g., the NRF). Thus, in response to the subscription request, the computing device may transmit an instance of the current profile to the NF consumer. The NF consumer may further send a second request to re-subscribe to the NF producer after the time period. The second request may include the instance of the profile stored at the NF consumer. Upon receiving the second request, the computing device may search the profile of the NF producer in a data storage.

In implementations, when the profile of the NF producer is discovered, the computing device may compare the instance of the profile provided by the NF consumer with the discovered profile and determine whether a difference between the instance of the profile and the profile. When there is a difference between the instance of the profile and the profile, the computing device may send a response to the NF consumer and indicate the difference between the instance of the profile and the profile in the response. The NF consumer may further update the instance of profile stored therein so that the instance of the profile of the NF producer is synchronized with the profile stored in the computing device (e.g., the NRF).

In implementations, the profile of the NF producer is not discovered in the data storage associated with the computing device. The computing device may send a discovery request to other NRFs in a regional NRF group and/or the NRFs in a remote NRF group. When the profile of the NF producer is discovered, the computing device may determine whether the discovered NF producer profile is different from the instance of the profile provided by the NF consumer. When there is a difference between the discovered NF producer profile and the instance of the profile provided by the NF consumer, the computing device may notify the NF consumer to update the instance of the profile stored therein. When the profile of the NF producer is not discovered, the computing device may reject the re-subscription request and set a re-subscribe timer for the NF consumer. The re-subscribe timer may indicate a time period, after which, the NF consumer can re-send the re-subscription request.

The present disclosure utilizes a re-subscribe timer when a re-subscription fails, to prevent too aggressive attempts to re-subscribe from the network functions, thus, alleviating unnecessary loads on the NRFs. Further, through reporting the instance of the NF producer profile along with the re-subscription request, the NRFs can determine the differences between the instance of the NF producer profile provided by the NF consumer and the current profile stored in the NRF. According to the present disclosure, in response to the re-subscription request, the NRF transmits the differences between the instance of the NF producer profile provided by the NF consumer and the current profile stored in the NRF to the NF consumer so that the NF consumer can update the instance of profile based on the differences, thus, ensuring the profiles stored in both the NF consumer and the NRF are synchronized.

The techniques discussed herein may be implemented in a computer network using one or more of protocols including but are not limited to Ethernet, 3G, 4G, 4G LTE, 5G, Sixth Generation (6G),other radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

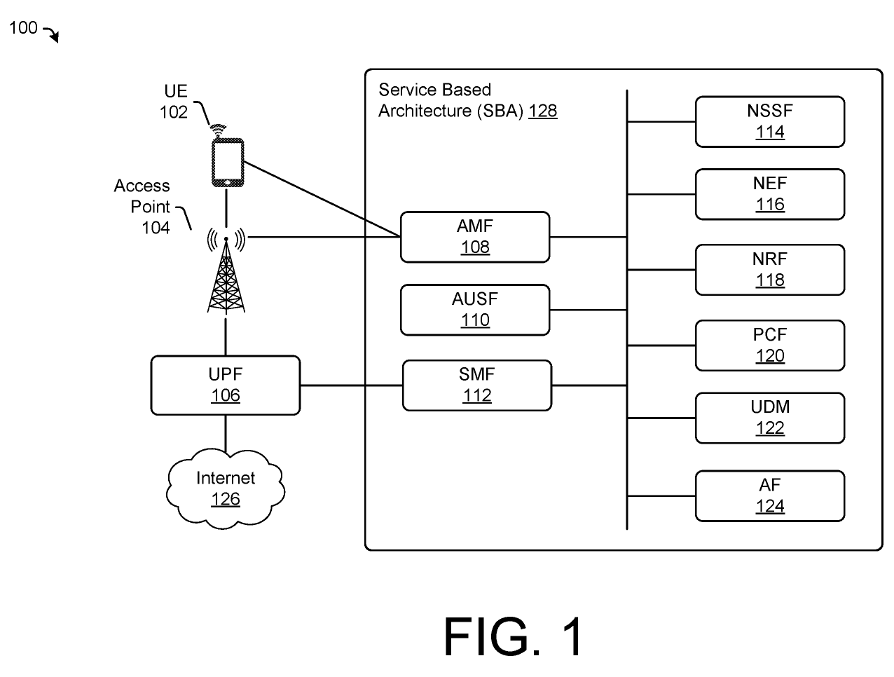

FIG. 1 illustrates an example network scenario, in which methods for improving network repository function subscription are implemented according to an example of the present disclosure.

The network scenario 100, as illustrated in FIG. 1, may be associated with a telecommunication network of a wireless service provider. A user equipment (UE) 102 may attach to a public land mobile network (PLMN) of the wireless service provider through an access point 104. The UE 102 may be any device that can wirelessly connect to a telecommunication network. The UE may support various radio access technologies such as Bluetooth, Wi-Fi, GSM, CDMA, WCDMA, UMTS, 4G/LTE or 5G NR. In some examples, the UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses.

In implementations, the access point 104 may be compatible with one or more radio access technologies, protocols, and/or standards, such as 5G New Radio (NR) technology, LTE/LTE Advanced technology, other fourth generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. For example, the access point 104 may be a gNB associated with a 5G radio access network (RAN) or an eNB associated with a 4G/LTE RAN. Although not shown, the access point 104 may also be associated with a second generation (2G) base station, a third generation (3G) NodeBs associated with GSM and CDMA access network, digital subscriber line (DSL) and variations of DSL technology that provide access to desktops, workstations, and/or mainframes, Wi-Fi connections to the user equipment, etc. The core network may be referred to as a backbone network of the telecommunication network, such as, a 5G core network, an evolved packet core (EPC) network, etc.

The PLMN of the wireless service provider may include a variety of network functions including but is not limited to, an access and mobility management function (AMF) 108, an authentication server function (AUSF) 110, a session management function (SMF) 112, a network slice selection function (NSSF) 114, a network exposure function (NEF) 116, a network repository function (NRF) 118, a policy control function (PCF) 120, a unified data management function (UDM) 122, an application function (AF) 124, a user plane function (UPF) 126, etc. In some examples, the AMF 108, the AUSF 110, the SMF 112, the NSSF 114, the NEF 116, the NRF 118, the PCF 120, the UDM 122, and the AF 124 may form a service-based architecture (SBA) 128 in the home PLMN.

The AMF 108 may be configured to manage the access and mobility of the mobile devices (e.g., UE 102). When a mobile device attaches to the PLMN through an access network (e.g., access point 104), the AMF 108 may send an authentication request to the AUSF 110 to perform an authentication on the subscriber associated with the mobile device. The AUSF 110 may interact with the UDM 122 to determine whether the identity and credentials of the subscriber are authorized to access the wireless network. The AUSF 110 may also determine the appropriate security context for the subscriber based on the identity, subscription data, and authorization level. The NSSF 114 may interact with the NRF 118 and the AMF 108 to exchange information about network slice selection for the services requested by the UE 102. The PCF 120 may be configured to enable efficient policy control and management, facilitating network behavior control, network slice selection, UE activities, and communication with other network functions. The UDM 122 may be configured to manage the user data, where a range of disparate data sources are consolidated to create a single source of data stored within a data warehouse. The NEF 116 may act as a centralized point of service exposure, allowing wireless carriers to securely handle valuable data coming from the AF 124 and enabling optimal allocation and utilization of network resources. The AF 124 may be configured to manage application-related functionalities. Once the subscriber associated with the UE 102 is authenticated, a communication session may be established for the UE 102 to access the Internet 126 through the UPF 106.

Through the service-based architecture (SBA) 128, a network function may access NF services exposed by one or more other network functions. The network function may be referred to as a NF consumer while the one or more other network functions may be referred to as NF producers. In implementations, all network functions in the SBA 128 may register their profiles in the NRF 118, and therefore, the NRF 118 can assist the NFs to discover each other and determine the services provided by other NFs. Further, the network functions may periodically update the NRF 118 with the status (e.g., capacity changes). Upon receiving an update request, the NRF 118 may update the profile corresponding to the network function in data storage.

In some examples, an NF consumer may subscribe to the status of an NF producer through the NRF 118. During the subscription, the NRF 118 may transmit a profile of the NF producer to the NF consumer. When receiving an update request from an NF producer, the NRF 118 may update the profile corresponding to the NF producer in the data storage. The NRF 118 may further notify one or more NF consumers subscribed to the NF producer regarding the update of the NF producer. In some examples, the NRF 118 may transmit a complete updated profile of the NF producer to the one or more NF consumers. In some other examples, the NRF 118 may transmit data indicating the differences between the updated profile and the profile previously stored in the data storage to the one or more consumers. For examples, the AMF 108 (i.e., the NF consumer) may discover a list of SMFs (i.e., the NF producers) and select the SMF 112 from the list to provide a service requested by the UE 102. The AMF 108 may subscribe, through the NRF 118, to receive the status of the selected SMF 112. When the NRF 118 receives a request to update the profile of the SMF 112, in addition to updating the profile in the data storage, the NRF 118 may also forward the data indicative of the profile update of the SMF 112 to the AMF 108. The AMF 108 may update the profile of the SMF 112 in its local storage.

As discussed herein, the NRF 118 may experience network issues and/or failures and cannot locate a NF profile associated with a re-subscription request to an NF producer. When multiple NRFs are deployed in a hierarchical topology, the NRF 118 may forward the request to other NRFs in the same hierarchy and/or an upper hierarchy. If the NF producer is still undiscoverable, an error code (e.g., code 404) indicating the profile not found is returned by the NRF 118 to the NF consumer. According to the present disclosure, the NRF 118 may generate a re-subscription timer and send it along with the error code to the NRF consumer. The re-subscription timer may indicate a time period that the NF consumer should wait until retrying the subscription. By utilizing the re-subscription timer, the present disclosure can prevent too aggressive attempts to re-subscribe from the network functions, thus, alleviating unnecessary loads on the NRFs.

In some examples, the NRF 118 may experience fault, causing part of the subscription data being lost. When receiving the re-subscription request from an NF consumer to an NF producer, the NRF 118 may be able to locate the profile of the NF producer. However, the profile of the NF producer may not match the profile previously saved in the NF consumer, depending on the time of the fault, the time of the subscription, or the time of a latest update. According to the present disclosure, when an NF consumer requests to re-subscribe to an NF producer, the NF consumer may also report a current profile of the NF producer to the NRF. Upon receiving the report of the current profile, the NRF 118 may compare the current profile with the profile in the data storage. The NRF 118 may further notify the NF consumer regarding the differences between the current profile and the profile in the data storage. As discussed herein, when an NF consumer reports the current profile in the local storage along with a re-subscription request, the NRFs can efficiently discover the discrepancies between the profile stored in the NF consumer and the profile stored in the NRF and ensure the synchronization of the NF producer profiles.

It should be understood that the network functions in the example network scenario 100 are for the purpose of illustration. The present disclosure is not intended to be limiting. The example network scenario 100 may include other network functions such as the charging function, the billing domain, etc. The role of a network function as an NF consumer or an NF producer may vary, depending on whether the network function consumes the services or provides the services. In some circumstances, a network function may act as a consumer when requesting a service provided by another network function. Yet in another circumstances, the network function may act as a producer when providing a service to another network function. For example, the AUSF 110 may act as an NF producer when performing authentication in response to a request from the AMF 108 (i.e., NF consumer). While interacting with the UDM 122 (e.g., NF producer) for verifying an identify of a subscriber, the AUSF 110 may, instead, act as an NF consumer. In another example, the AMF 108 may use the service provided by the SMF 112, and thus, act as a NF consumer. While the NSSF 114 evaluates the AMFs to determine which AMF to support a UE with designated network slices, the NSSF 114 may obtain capacity data of the AMFs (e.g., a number of UEs currently supporting). In such circumstances, the AMF may act as a NF producer and the NSSF 114 may act as a NF consumer.

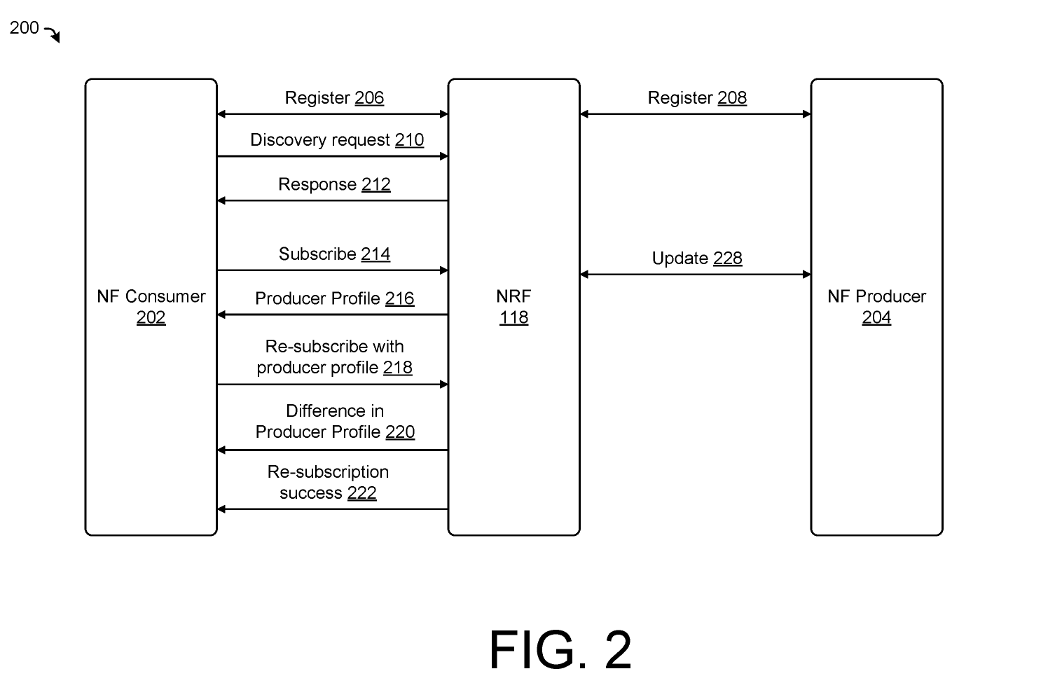

FIG. 2 illustrates an example scenario, in which methods for improving network repository function subscription are implemented according to an example of the present disclosure.

As illustrated in the example scenario 200, an NF consumer 202 may register, at operation 206, in the NRF 118. During the registration, a current profile of the NF consumer 202 may be sent to the NRF 118 to be saved in a data storage. Once the registration is complete, the NF consumer 202 may send a discovery request, at operation 210, to the NRF 118. The discovery request may request to discover an NF producer that provides the service. The NRF 118 may search the data storage and discover one or more NF producer profiles. For example, a discovery request from an AMF (e.g., AMF 108 in FIG. 1) may cause the NRF 118 to discover one or more SMF profiles (e.g., SMF 112 in FIG. 1). The NRF 118 may send, at operation 212, a response to the NF consumer 202 with a list of the NF producer profiles. Upon receiving the list of NF producer profiles, the NF consumer 202 may determine an NF producer (e.g., NF producer 204) to provide the service. As discussed herein, the NF producer 204, as another network function, may register, at operation 208, in the NRF 118. Similarly, during the registration, a current profile of the NF producer 204 may be sent to the NRF 118 to be saved in a data storage. In implementations, the NF consumer 202 and the NF producer 204, after the initial registration, may periodically send an update request to the NRF 118 to update the profile (e.g., the update operation 228 from the NF producer 204 to the NRF 118).

In implementations, the NF consumer 202 may subscribe, at operation 214, to the NF producer 204 to receive updates. In response to the subscription request of the NF consumer 202, the NRF 118 may return, at operation 216, the saved profile of the NF producer 204 to the NF consumer 202. In some examples, the NF consumer 202 may send a request, at operation 218, to re-subscribe to the NF producer 204 with a producer profile. The producer profile may be the profile last saved in the NF consumer 202. Upon receiving the request to re-subscribe and the producer profile, the NRF 118 may search the data storage for the profile of the NF producer 204. When the profile of the NF producer 204 is found, the NRF 118 may compare the profile saved in the data storage with the profile sent by the NF consumer 202. The NRF 118 may then send, at operation 220, the difference between the profile saved in the data storage with the profile sent by the NF consumer 202, to the NF consumer 202. Alternatively, when there is no difference between the profile saved in the data storage with the profile sent by the NF consumer 202, the NRF 118 may send a response to the NF consumer 202, indicating that the NF producer profiles are synchronized. The NRF 118 may further send, at operation 222, a re-subscription success response to the NF consumer 202. In some examples, the NRF 118 may discover one or more instances of the NF producer profile. The NRF 118 may select a latest instance to compare with the profile provided by the NF consumer 202.

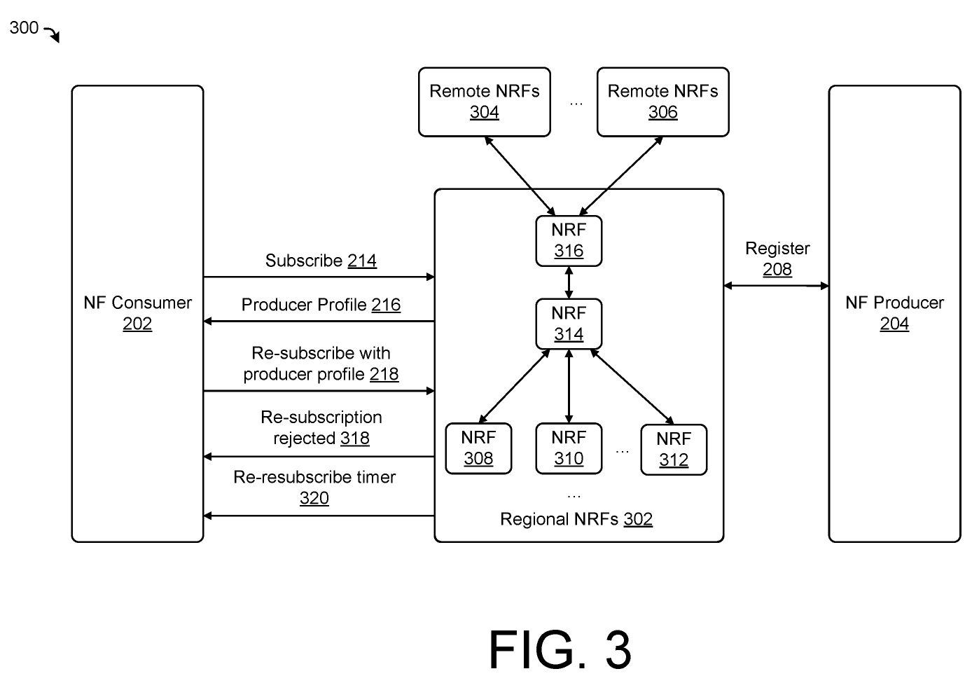

FIG. 3 illustrates an example scenario, in which methods for improving network repository function subscription are implemented according to another example of the present disclosure.

As illustrated in the example scenario 300, the NF consumer 202 may subscribe through the NRF 118, at operation 214, to the NF producer 204. The NF consumer 202 may receive, at operation 216, the producer profile of the NF producer 204. The profile of the NF producer 204 may be saved in the NRF 118 during the initial registration (e.g., operation 208) and updated periodically. When the NF consumer 202 sends a re-subscribe request with the producer profile at operation 218, a regional NRF (e.g., NRF 308) receiving the request may search the data storage for the producer profile. If no producer profile is found, the NRF 308 may forward the request to the other NRFs in the regional NRFs 302, e.g., the NRF 314, the NRF 310, the NRF 312, etc. If the producer profile is still not found in the regional NRFs 302, a gateway NRF (e.g., NRF 316) in the region may further forward the request to the global NRFs such as, the remote NRFs 304, the remote NRFs 306, etc. If the producer profile cannot be discovered in the reginal NRFs and the remote NRFs, the NRF 308 may send, at operation 318, a response to the NF consumer 202, indicating the re-subscription being rejected. In some examples, the NRF 308 may further send, at operation 320, a re-subscribe timer, to the NF consumer 202. The re-subscriber timer may indicate a time period, after which, the NF consumer 202 can re-try the subscription to the NF producer 204.

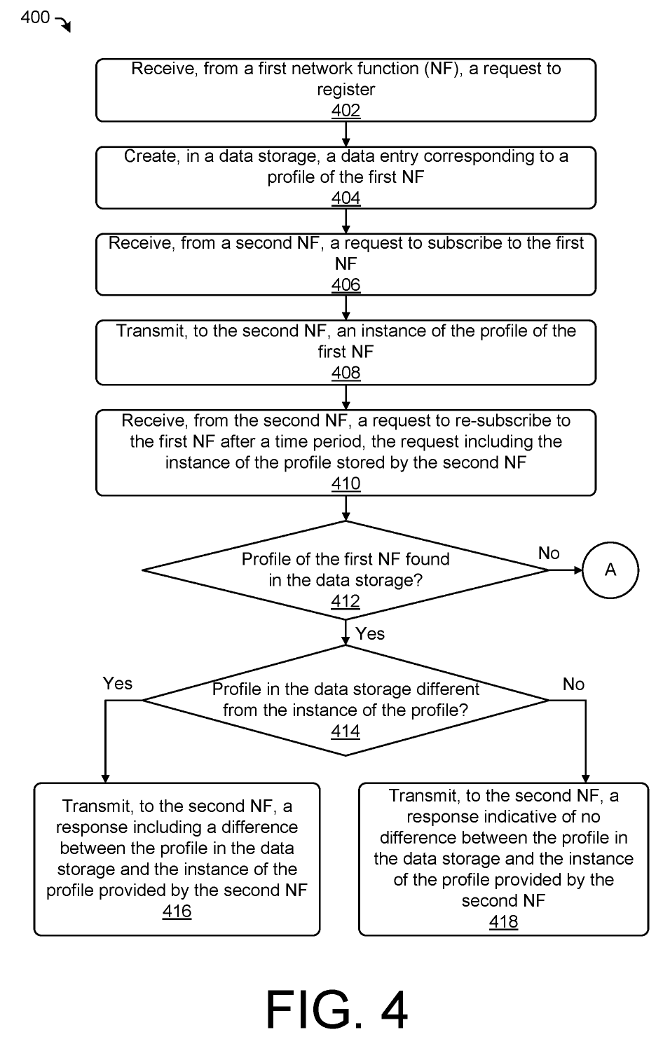

FIG. 4 illustrates an example process for improving network repository function subscription according to an example of the present disclosure. The example process 400 may be performed by a computing device associated with the network repository function in a wireless communication network (e.g., NRF 118 of FIG. 1).

At operation 402, the process may include receiving, from a first network function, a request to register. As discussed herein, the first NF may include any network functions associated with a wireless communication network, such as a 5G network. The first NF may send its profile to be saved in the computing device, e.g., the NRF.

At operation 404, the process may include creating, in a data storage, a data entry corresponding to the profile of the first NF. The data storage may be associated with the NRF and include multiple central storages and distributed storages. In some examples, the multiple central storages and distributed storages may be deployed in a cloud-based architecture. The data entry corresponding to the profile of the first NF may be saved in one or more NRFs. The profile may include one or more parameters associated with the first NF such as capacities of the first NF, availability of the first NF, etc. In implementations, the data entry corresponding to the profile of the first NF may include a time stamp indicative of a time when the profile is saved.

At operation 406, the process may include receiving, from a second NF, a request to subscribe to the first NF. In this circumstance, the second NF may be a NF consumer that consumes the service provided by the first NF (i.e., the NF producer). The second NF may subscribe to the first NF to receive updates of the first NF. As discussed herein, the second NF may also register its profile with the NRF and periodically report to the NRF any update on the profile.

At operation 408, the process may include transmitting, to the second NF, an instance of the profile of the first NF. As discussed herein, the NRF may store an up-to-date instance of the first NF profile. In response to the subscription request of the second NF to the first NF, the NRF may send the up-to-date instance of the first NF profile to the second NF.

At operation 410, the process may include receiving, from the second NF, a request to re-subscribe to the first NF after a time period, the request including the instance of the profile stored by the second NF. In some examples, the second NF may not receive the update of the first NF profile from the first NF for a time period. The second NF may determine the subscription may be lost and request the NRF to re-subscribe to the first NF. To facilitate the NRF to locate the correct profile of the first NF, the second NF may include the instance of the profile of the first NF stored in its local storage in the request to re-subscribe as a reference.

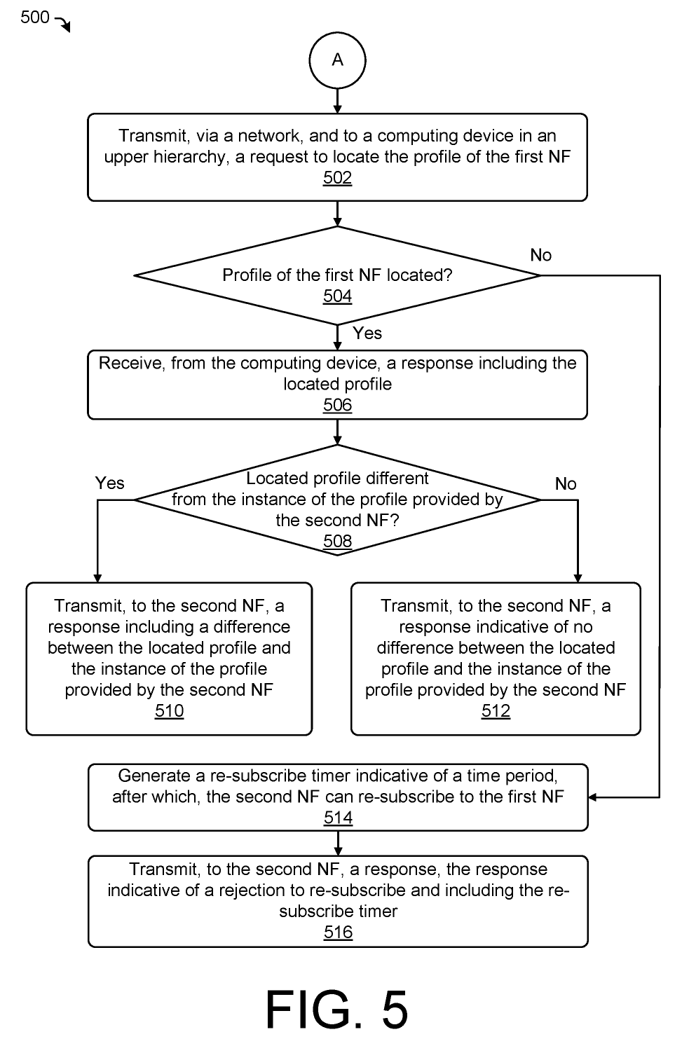

At operation 412, the process may include determining whether the profile of the first NF is found in the data storage associated with the NRF. When the profile of the first NF is not found in the data storage, the process may continue at operation A, as described with respect to FIG. 5.

When the profile of the first NF is found in the data storage, at operation 414, the process may include determining the profile in the data storage is different from the instance of the profile in the request to re-subscribe. The NRF may compare the parameters indicated in both profiles and the time stamps associated with both profiles to determine any discrepancies.

When the profile of the first NF in the data storage is different from the instance of the profile of the first NF, at operation 416, the process may include transmitting, to the second NF, a response including a difference between the profile in the data storage and the instance of the profile provided by the second NF. For example, the difference may indicate a capacity change of the first NF, an availability change of the first NF, a time stamp different, etc. When receiving the response, the second NF may update the profile of the first NF stored therein so that the profile in the local storage of the second NF is synchronized with the instance saved in the NRF. The process at operation 416 may further include transmitting a response to the first NF. The response to the first NF may also indicate the re-subscription request is complete.

When the profile of the first NF in the data storage is not different from the instance of the profile of the first NF, at operation 418, the process may include transmitting, to the second NF, a response indicative of no difference between the profile in the data storage and the instance of the profile provided by the second NF.

FIG. 5 illustrates an example process for improving network repository function subscription according to another example of the present disclosure. The example process 500 may be performed by a computing device associated with the network repository function in a wireless communication network (e.g., NRF 118 of FIG. 1). The example process 500 may follow the operation 412 of the example process 400 as described above.

At operation 502, the process may include transmitting, via a network, and to a computing device in an upper hierarchy, a request to locate the profile of the first NF. The computing device may be associated with other NRFs in the wireless network. As discussed herein, multiple NRFs may be implemented in a hierarchical architecture. In some examples, a regional NRF group, a global NRF group, or a remote NRF group, may each include multiple NRFs implemented in a hierarchical architecture. One NRF in each group may act as a gateway NRF to route the NF profile discovery request to other NRF groups. When the profile of the first NF is not found, the NRF may forward the request to other NRFs to locate the profile.

At operation 504, the process may include determining whether the profile of the first NF is located. When the profile of the first NF is located, at operation 506, the process may include receiving, from the computing device, a response including the located profile.

At operation 508, the process may include determining whether the located profile is different from the instance of the profile of the first NF provided by the second NF. Similar to the operation 414 of the example process 400, the NRF may compare the parameters of both profiles and the time stamps associated with both profiles and determine whether there are any differences.

When the located profile is different from the instance of the profile of the first NF provided by the second NF, at operation 510, the process may include transmitting, to the second NF, a response including a difference between the located profile and the instance of the profile provided by the second NF. The operation 510 is similar to the operation 416 as described in the example process 400. When the located profile is not different from the instance of the profile of the first NF provided by the second NF, at operation 512, the process may include transmitting, to the second NF, a response indicative of no difference between the located profile and the instance of the profile provided by the second NF. The operation 512 is similar to the operation 418 as described in the example process 400.

When the profile of the first NF is not located in any of the NRFs, the process may continue at operation 514. The process may include generating a re-subscribe timer indicative of a time period, after which, the second NF can re-subscribe to the first NF. As discussed herein, by setting the re-subscribe timer, the second NF may hold the request to re-subscribe rather than randomly re-try the subscription aggressively. At operation 516, the process may include transmitting, to the second NF, a response that is indicative of a rejection to re-subscribe and including the re-subscribe timer.

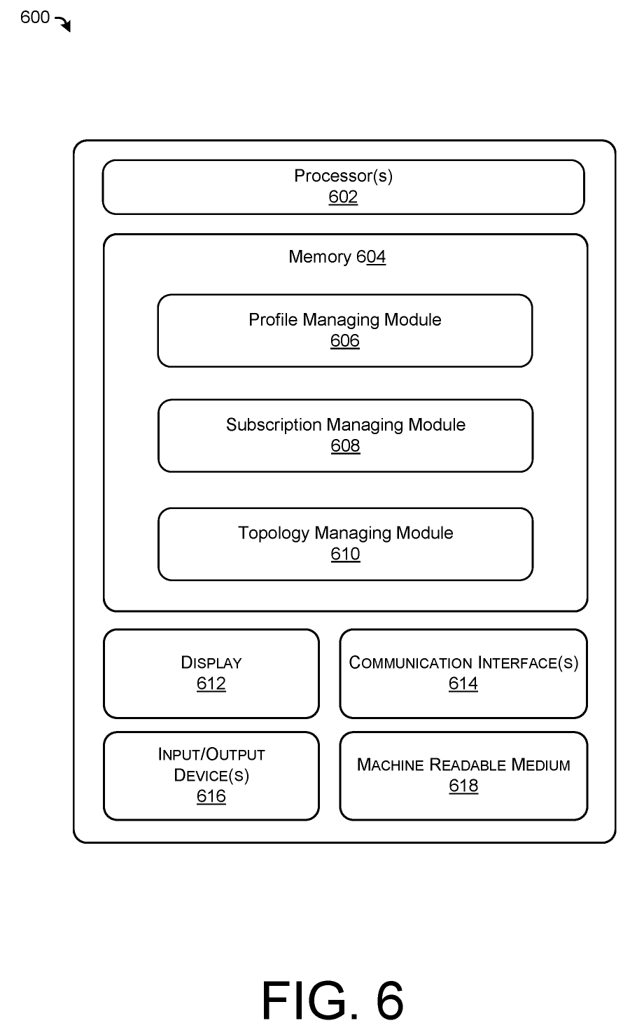

FIG. 6 illustrates an example computing device, in which methods for improving network repository function subscription are implemented according to an example of the present disclosure. The example computing device 600 may correspond to the computing device associated with the network repository function in a wireless communication network (e.g., NRF 118 of FIG. 1).

As illustrated in FIG. 6, a computing device 600 may comprise processor(s) 602, a memory 604 storing a profile managing module 606, a subscription managing module 608, and a topology managing module 610, a display 612, communication interface(s) 614, input/output device(s) 616, and/or a machine readable medium 618.

In various examples, the processor(s) 602 can be a central processing unit (CPU), a graphics processing unit (GPU), or both CPU and GPU, or any other type of processing unit. Each of the one or more processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 602 may also be responsible for executing all computer applications stored in memory 604, which can be associated with common types of volatile (RAM) and/or nonvolatile (ROM) memory.

In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 600. Any such non-transitory computer-readable media may be part of the computing device 600.

The profile managing module 606 may be configured to create, modify, and manage the profiles of various network functions in the wireless communication network. The profile managing module 606 may periodically update the profiles stored therein based on the update report from these network functions. In some examples, the network function profile may indicate a current resource usage of the network function, a current processing capacity of the network function, etc. For example, an SMF profile may indicate a number of protocol data unit (PDU) sessions currently supported by the SMF. In another example, an AMF profile may indicate a number of UEs that is currently served by the AMF.

The subscription managing module 608 may be configured to manage the subscriptions among various network functions. For example, the subscription managing module 608 may create a subscription for an NF consumer to an NF producer. The subscription managing module 608 may share the profile of the NF producer with the NF consumer during the initial subscription. The subscription managing module 608 may periodically send the updates on the NF producer profile to the NF consumer. The subscription managing module 608 may also process re-subscription request, de-subscription request, etc., from an NF consumer.

The topology managing module 610 may be configured to manage the topology information of the NRFs when multiple NRFs are deployed in the wireless communication network. For example, the topology managing module 610 may maintain a dynamic routing table of the NRFs so as to route the profile discovery request to other NRFs.

The communication interface(s) 614 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 614 can be compatible with multiple radio access technologies, such as 5G radio access technologies and 4G/LTE radio access technologies. Accordingly, the communication interfaces 614 can allow the computing device 600 to connect to the 5G system described herein.

Display 612 can be a liquid crystal display or any other type of display commonly used in the computing device 600. For example, display 612 may be a touch-sensitive display screen and can then also act as an input device or keypad, such as for providing a soft-key keyboard, navigation buttons, or any other type of input. Input/output device(s) 616 can include any sort of output devices known in the art, such as display 612, speakers, a vibrating mechanism, and/or a tactile feedback mechanism. Input/output device(s) 616 can also include ports for one or more peripheral devices, such as headphones, peripheral speakers, and/or a peripheral display. Input/output device(s) 616 can include any sort of input devices known in the art. For example, input/output device(s) 616 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 618 can store one or more sets of instructions, such as software or firmware, which embodies any one or more of the methodologies or functions described herein. The instructions can also reside, completely or at least partially, within the memory 604, processor(s) 602, and/or communication interface(s) 614 during execution thereof by the computing device 600. The memory 604 and the processor(s) 602 also can constitute machine readable media 618.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computing device, comprising:
a processor;
a non-transitory computer-readable memory storing computer-executable instructions that, when executed by the processor, cause the processor to perform actions including:
receiving, from a network function consumer, a request to subscribe to a network function producer;
transmitting, to the network function consumer and in response to the request, an instance of a profile of the network function producer;
receiving, from the network function consumer, a second request to re-subscribe to the network function producer;
locating the profile of the network function producer; and
transmitting, to the network function consumer and based at least in part on the profile, a response to the second request.

2. The computing device of claim 1, wherein the second request includes the instance of the profile of the network function producer.

3. The computing device of claim 2, wherein the computer-executable instructions, when executed by the processor, cause the processor to perform actions including:
comparing the instance of the profile to the profile; and
determining a difference between the instance of the profile and the profile.

4. The computing device of claim 3, wherein the response to the second request indicates the difference between the instance of the profile and the profile.

5. The computing device of claim 4, wherein the response to the second request causes the network function consumer to update the instance of the profile based at least in part on the difference.

6. The computing device of claim 1, wherein the computer-executable instructions, when executed by the processor, cause the processor to perform actions including:
determining that a data storage does not include the profile of the network function producer;
forwarding, via a network, the second request to a second computing device in an upper hierarchy; and
receiving, via the network and from the second computing device, the profile of the network function producer.

7. The computing device of claim 1, wherein the computer-executable instructions, when executed by the processor, cause the processor to perform actions including:
determining that a data storage associated with the computing device does not include the profile of the network function producer;
forwarding, via a network, the second request to a second computing device in an upper hierarchy;
receiving, via the network and from the second computing device, a second response indicative of the profile of the network function producer not found; and
generating a re-subscriber timer indicative a time period, after which, the network function consumer can re-send the request to subscribe to the network function producer.

8. The computing device of claim 7, wherein the response to the second request includes the re-subscriber timer.

9. A computer-implemented method, comprising:
receiving, from a network function consumer, a request to subscribe to a network function producer;
transmitting, to the network function consumer and in response to the request, an instance of a profile of the network function producer;
receiving, from the network function consumer, a second request to re-subscribe to the network function producer;
locating the profile of the network function producer; and
transmitting, to the network function consumer and based at least in part on the profile of the network function producer, a response to the second request.

10. The computer-implemented method of claim 9, wherein the second request includes the instance of the profile of the network function producer.

11. The computer-implemented method of claim 10, further comprising:
comparing the instance of the profile to the profile; and
determining a difference between the instance of the profile and the profile.

12. The computer-implemented method of claim 11, wherein the response to the second request indicates the difference between the instance of the profile and the profile.

13. The computer-implemented method of claim 12, wherein the response to the second request causes the network function consumer to update the instance of the profile of the network function producer based at least in part on the difference.

14. The computer-implemented method of claim 9, further comprising:
determining that a data storage does not include the profile of the network function producer;
forwarding, via a network, the second request to a computing device in an upper hierarchy; and
receiving, via the network and from the computing device, the profile of the network function producer.

15. The computer-implemented method of claim 9, further comprising:
determining that a data storage does not include the profile of the network function producer;
forwarding, via a network, the second request to a computing device in an upper hierarchy;
receiving, via the network and from the computing device, a second response indicative of the profile of the network function producer not found; and
generating a re-subscriber timer indicative a time period, after which, the network function consumer can re-send the request to subscribe to the network function producer.

16. The computer-implemented method of claim 15, wherein the response to the second request includes the re-subscriber timer.

17. A computer-readable storage medium storing computer-readable instructions, that when executed by a processor, cause the processor to perform operations comprising:
receiving, from a network function consumer, a request to subscribe to a network function producer;
transmitting, to the network function consumer and in response to the request, an instance of a profile of the network function producer;
receiving, from the network function consumer, a second request to re-subscribe to the network function producer;
locating the profile of the network function producer; and
transmitting, to the network function consumer and based at least in part on the profile of the network function producer, a response to the second request.

18. The computer-readable storage medium of claim 17, wherein the second request includes the instance of the profile of the network function producer.

19. The computer-readable storage medium of claim 18, wherein the computer-readable instructions, when executed by a processor, cause the processor to perform operations comprising:
comparing the instance of the profile to the profile; and
determine a difference between the instance of the profile and the profile,
wherein the response to the second request indicates the difference between the instance of the profile and the profile.

20. The computer-readable storage medium of claim 17, wherein the computer-readable instructions, when executed by a processor, cause the processor to perform operations comprising:
determine that a data storage does not include the profile of the network function producer;
forwarding, via a network, the second request to a computing device in an upper hierarchy;
receiving, via the network and from the computing device, a second response indicative of the profile of the network function producer not found; and
generating a re-subscriber timer indicative a time period, after which, the network function consumer can re-send the request to subscribe to the network function producer,
wherein the response to the second request includes the re-subscriber timer.
